(19) United States
(12) Patent Application Publication
(10) Pub. No.: US 2016/0130144 A1
(43) Pub. Date: May 12, 2016

(54) Method and Process of Treatment of Selenium Containing Material and Selenium Recovery

(71) Applicants: Gioulchen Tairova, Cobourg (CA); Junian Ioffe, Cobourg (CA)

(72) Inventors: Gioulchen Tairova, Cobourg (CA); Junian Ioffe, Cobourg (CA)

(21) Appl. No.: 14/537,987

(22) Filed: Nov. 11, 2014

(51) Int. Cl. C01B 19/02; C01B 19/00

(52) U.S. Cl. CPC C01B 19/02; C01B 19/008

(57) ABSTRACT

The method and process of treatment of selenium containing materials, including, but not limited to, different adsorbents, membranes, filters, bioreactor sludge obtained from water treatment, waste electronic devices, material obtained from mineral processing, different industrial wastes, metallurgical wastes, which allow reduction of total selenium content in the material and selenium recovery have been developed.

### BACKGROUND

There is a large inventory of materials containing selenium, including different adsorbents, bioreactor sludge obtained from biological water treatment, ion exchange resins, waste electronic devices, and solar cells. These materials can be treated to remove/recover selenium and returned back to service or disposed of as non-hazardous waste. The selenium concentration in the materials for disposal must be tested using the USEPA Toxicity Characteristic Leaching Procedure (TCLP) 1311 to determine how it must be disposed: as a non-hazardous waste or as a more expensive hazardous waste. If the TCLP result for selenium is over 1.0 mg/L, the waste must be stored in a hazardous waste landfill area. In addition to a high cost, the stored or landfilled waste, which contains selenium, may under certain conditions, such as high groundwater pH, release selenium posing environmental hazard. The present invention is related to treatment of the solid materials, including solid waste, different spent adsorbents, saturated ion exchange resin, bioreactor sludge, and electronic devices, to regenerate the material for re-use or to produce a non-hazardous waste and to recover selenium.

### DESCRIPTION OF PREVIOUS ART

Methods that are currently used for selenium recovery from such wastes are elaborate and require high temperatures, several complex steps prior to selenium removal from the material, followed by selenium recovery.

In the patent No. CA 1337019 C, two biomass treatment options to remove/recover selenium are suggested. In the first option, heating the biomass to 105-110° C. with alkaline solution is proposed. In the second option, reacting biomass with boiling Na₂SO₃ or NaHSO₃ solutions is proposed. Both options are not only expensive and elaborate due to the requirement to heat to high temperatures, but also are not very safe, considering that all these reagents are very corrosive at high temperatures and, in addition, in Option 2, a very corrosive sulfur dioxide gas is released.

In the patents EP2651817 A1, EP 2651818 A1, WO2012082251 A1, a process to treat bioreactor sludge, followed by oxidation in alkaline solution to dissolve selenium then precipitation of selenium salts, was described. This process calls for several elaborate steps, including complex filtration, followed by application of oxidizing agents, such as Cl₂, H₂O₂ and MnO₄ to convert selenium species to a soluble form.

Bioreactor sludge is obtained from the treatment of wastewater which contained selenium. The microbes in the bioreactor convert the selenium present in wastewater to elemental selenium. The elemental selenium, which is generally present in the bioreactor sludge in a red allotropic form, is not readily soluble in alkaline solutions. In alkaline solutions it is converted to a black-grey vitreous form of selenium, which is not readily soluble in any of the above listed solutions in the presence of oxidizing agents at ambient temperatures. Recovery of selenium from these solutions, using reducing compounds or electrowinning process is not economically viable.

In addition to these disadvantages, the application of extremely corrosive and toxic chemicals, such as chlorine, require extra safety precautions during the operation of the plant.

### DETAILED DESCRIPTION OF INVENTION

The first objective of the present invention is related to treatment of the solid materials, including solid waste, different spent adsorbents, saturated ion exchange resins, bioreactor sludge, and electronic devices, to regenerate the material for re-use or to produce a non-hazardous waste.

The second objective of this invention is to recover selenium values.

The present invention has several benefits and advantages.

One benefit of the invention is that selenium-contaminated materials can be economically treated to provide solids that are within acceptable environmental safety limits.

Another benefit of the invention is that the water-insoluble adsorption media after the treatment can be reused multiple times without loss of capacity or efficiency.

Another advantage of the Invention is that selenium can be substantially completely removed from selenium-containing solid materials and recovered in a pure form for further use.

Another benefit of the invention is that the proposed process uses readily available equipment and materials.

Another advantage of the invention is that the proposed process is easy to implement and does not require highly specialized equipment.

Another advantage of the invention is that the selenium can be removed with higher efficiency than was previously attainable and at more mild conditions, without using high temperatures.

Further advantages of the invention will be apparent from the following disclosure.

In this invention we disclose that elemental selenium in different allotropic forms as well as selenium compounds can be easily removed from most materials by contacting with alkaline solutions, which contain sulfide, at ambient temperatures. It must be noted that this observed enhancement in selenium solubility was quite unexpected: generally, dissolution of the black vitreous forms of selenium is possible at high temperatures using strong oxidizing conditions. The source of sulfide may be, but not limited to, sodium sulfide, potassium sulfide, lithium sulfide, or any mixture thereof. The alkaline compounds used may include, but not limited to, sodium hydroxide, potassium hydroxide, lithium hydroxide, sodium carbonate, potassium carbonate, lithium carbonate or any mixture thereof. In adsorbents, based on elements, such as, but not limited to, iron, zinc, copper, tin compounds, including, but not limited to, sulfides, oxides, supported on alumina, silica, activated carbon, or polymer supports, selenium may be present as elemental selenium, selenate, selenite or selenide. In bioreactor sludge, selenium is mainly present in elemental form. Some adsorbents, e.g., based on ferric oxyhydroxides, contain selenium in the form of selenite and selenate, which can be removed by reaction with alkaline solutions, without sulfide addition.

The material to be processed is submitted for total selenium analysis before and after the treatment. In the proposed process, the material is contacted with alkaline solution with or without sulfides.

After the reaction with alkaline solutions or with alkaline solutions containing sulfide, the solids in the reaction mixture are separated by solid-liquid separation method, e.g. filtration, centrifuging. The solids are washed, dried and analyzed for selenium content. In the treated solids obtained, the selenium concentration is generally below 03 mg/L.

The solutions obtained are treated to recover selenium using different options. One of these options of selenium recovery from the sulfide-containing alkaline solutions is the reaction with oxidizing compounds, such as, but not limited to, sodium percarbonate, hydrogen peroxide, oxygen, or a mixture thereof, at a pH higher than 7. The main product obtained is elemental selenium.

The other option of selenium recovery from the solutions containing sulfide is acidification to pH less than 7. In this case, the selenium is co-precipitated with sulfur. Formation of selenium sulfide and some hydrogen sulfide is also observed.

The other options to precipitate elemental selenium from the solutions obtained after the alkaline leaching of the solid material, which contains selenites and selenates, includes the reaction with reducing compounds, such as ascorbic acid, thiourea and hydroxylamine, or a mixture thereof. Selenium is precipitated in elemental form.

Some additional options of selenium recovery from the alkaline solutions obtained include the reaction with salts, such as ferric and ferrous chloride, which produce insoluble selenites or selenates.

Based on the experimental results obtained, the process of selenium recovery from different materials was suggested.

Depending on the composition of the material to be treated, selenium may be present in it in different forms. In adsorbents, based on iron, zinc, copper, and on the compounds of these elements, supported on alumina, silica, and/or activated carbon, selenium may be present as elemental selenium, selenate, selenite or selenide. In bioreactor sludge selenium is mainly present in elemental form.

The selenium, contained in different materials in various forms, was treated as described below. The material was contacted with alkaline solution, which contained sulfide. The selenium contained in different forms was dissolved and the solution was separated by solid-liquid separation. The selenium was recovered from the solution by precipitation.

There are different options for disposition of the solids after the removal of selenium.

The materials, such as adsorbents, ion exchange resins, bioreactor sludge, can be regenerated, then recycled/re-used. It was observed that the adsorption media could be repeatedly treated (e.g., regenerated), rinsed and reused, without noticeable physical or chemical degradation of the selenium binding capacity of the material.

The other option is the disposal of these materials as a less expensive and environmentally friendly non-hazardous waste. The bioreactor sludge after the removal of selenium can be re-used or landfilled as a non-hazardous waste or incinerated.

The invention can also be applied for selenium recovery from the waste after drying, pyrolysis or Incineration, which would allow selenium recovery and reduction of total volume of non-hazardous solid waste.

The following examples are provided for illustration purposes only and should not be considered to limit the scope of the invention to the methods described herein.

### Example 1

100 g of a composite adsorbent, based on iron oxyhydroxides, iron granular, ferrous sulfide, zinc sulfide, alumina, silica and activated carbon, which contained 450 ppm selenium, was reacted with 300 mL of a solution, which contained 0.5 wt % of sodium hydroxide and 0.1 wt % of sodium sulfide solution for 1 hour, then the solids were separated from the liquid phase by filtration, then washed on a filter with 100 mL water. The solids obtained were dried and submitted for total selenium analyses. The total selenium concentration in the solids was 0.2 ppm. The combined filtrate obtained was reacted with 0.2 g of sodium percarbonate to precipitate red solids, which were separated by filtration. The filtrate was recycled for re-use. The solids obtained were identified by SEM/EDX analysis as elemental selenium.

### Example 2

500 g of composite adsorbent, based on iron oxyhydroxides, alumina, silica and activated carbon, which contained 350 ppm total selenium, was reacted with 1000 mL of a solution, which contained 3 wt % of sodium hydroxide, for 30 minutes, then the solids were separated from the liquid phase by filtration, washed on a filter with 200 mL of water, dried and submitted for total selenium analysis. The results of the analysis indicated the presence of 0.3 ppm of selenium in the treated solids. To the filtrate obtained, 2 g of thiourea was added, the pH was reduced to 6.7 to precipitate red solids, which were separated by filtration. The filtrate was recycled for re-use. The solids obtained were identified by SEM/EDX analysis as elemental selenium.

### Example 3

The adsorbent (100 g) based on iron oxyhydroxides, alumina, silica and activated carbon, in a suitable glass column equipped with inlet and outlet, which contained 600 mg of total selenium, was reacted with 300 mL of solution, which contained 1 wt % of sodium hydroxide and which was circulated through the column at a flowrate 200 mL/min for 20 minutes using a peristaltic pump. After twenty minutes, the circulation was stopped, the column was washed with 100 mL of water. The concentration of selenium in the sample of the column material after the treatment was 0.15 ppm. The eluate solutions obtained were combined. Then 1 g of thiourea was added to the solution and the pH was adjusted to 6.7 to obtain a red precipitate. The precipitate was separated by filtration, washed and dried. The liquid phase was recycled for re-use. The precipitate obtained was identified by SEM/EDX analysis as selenium. The regenerated adsorbent was re-used for water treatment.

### Example 4

The waste bioreactor sludge obtained from selenium removal using a biological method (500 g), which contained 200 ppm of total selenium in solids (dried basis), was centrifuged, the solids obtained were separated from the liquid, added to the reaction vessel, equipped with mechanical stirrer, and reacted with 200 ml of solution containing 5 wt % sodium sulfide, while mixing, then the solution was separated from the solids. The solids were washed with 200 mL water, a sample of the solids was dried and submitted for analysis. The solids after the treatment contained 0.3 ppm of selenium. The liquids obtained were combined and 2 g of sodium percarbonate was added to obtain a red precipitate. The precipitate was separated by filtration. The filtrate was recycled for re-use. The precipitate was identified by SEM/EDX analysis as elemental selenium.

### Example 5

The waste bioreactor sludge obtained from selenium removal using a biological method (500 g), which contained 1000 ppm of total selenium in solids (dried basis), was centrifuged, the solids obtained were separated from the liquid, added to the reaction vessel, equipped with mechanical stirrer, and reacted with 200 mL of solution containing 5 wt % sodium sulfide, while mixing, then the solution was separated from the solids. The solids were washed with 200 mL water, a sample of the solids was dried and submitted for analysis. The solids after the treatment contained 0.4 ppm of selenium. The liquids obtained were combined and 50 mL of 10 wt % sodium carbonate and 5 wt % hydrogen peroxide solution was added to obtain a red precipitate. The precipitate was separated by filtration. The filtrate was recycled for re-use. The precipitate was identified by SEM/EDX analysis as elemental selenium.

### Example 6

The waste bioreactor sludge obtained from selenium removal using a biological method (500 g), which contained 500 ppm of total selenium in solids (dried basis), was centrifuged, the solids obtained were separated from the liquid, added to the reaction vessel, equipped with mechanical stirrer, and reacted with 200 mL of solution containing 3 wt % of sodium sulfide, while mixing, then the solution was separated from the solids. The solids were washed with 200 mL water, a sample of the solids was dried and submitted for analysis. The solids after the treatment contained 0.4 ppm of selenium. The liquids obtained were combined and 5 g of 30 wt % hydrogen peroxide was added to obtain a black precipitate. The precipitate was separated by filtration. The filtrate was recycled for re-use. The precipitate was identified by SEM/EDX analysis as elemental selenium.

### Example 7

The waste bioreactor sludge obtained from selenium removal using a biological method (500 g), which contained 1100 ppm of total selenium in solids (dried basis), was centrifuged, the solids obtained were separated from the liquid, added to the reaction vessel, equipped with mechanical stirrer, and reacted with 250 mL of solution containing 3 wt % of sodium sulfide, while mixing, then the solution was separated from the solids. The solids were washed with 200 mL water, a sample of the solids was dried and submitted for analysis. The solids after the treatment contained 0.5 ppm of selenium. The liquids obtained were combined and 20 mL of 20 wt % potassium persulfate was added to obtain a precipitate. The precipitate was separated by filtration. The filtrate was recycled for re-use. The precipitate was identified by SEM/EDX analysis as elemental selenium.

### Example 8

The waste bioreactor sludge obtained from selenium removal using a biological method (500 g), which contained 250 ppm of total selenium in solids (dried basis), was centrifuged, the solids obtained were separated from the liquid, added to the reaction vessel, equipped with mechanical stirrer, and reacted with 200 ml of solution containing 1 wt % of sodium sulfide and 1 wt % of sodium hydroxide, while mixing, then the solution was separated from the solids. The solids were washed with 200 ml of water, a sample of the solids was dried and submitted for analysis. The solids after the treatment contained 0.2 ppm of selenium. The liquids obtained were combined and 2 g of ascorbic acid was added to obtain a black precipitate. The precipitate was separated by filtration. The filtrate was recycled for re-use. The precipitate was identified by SEM/EDX analysis as elemental selenium.

### Example 9

300 g of bioreactor sludge, which contained 1800 ppm of total selenium in solids (dried basis), was centrifuged, the solids obtained were separated from the liquid, heated in an oven at 300° C. for 4 hours in the presence of air. The solids obtained were removed, reacted with 200 mL of 1 wt % sodium hydroxide solution, then the solution was separated from the solids by filtration. The solids were washed and dried and submitted for analysis. The solids contained 0.3 ppm of selenium. 3 g of ascorbic acid was added to the filtrate to obtain a red precipitate. The precipitate was separated by filtration. The filtrate was recycled for re-use. The precipitate was identified by SEM/EDX analysis as elemental selenium.

### Example 10

300 g of bioreactor sludge, which contained 550 ppm of total selenium in solids (dried basis), was centrifuged, the solids obtained were separated from the liquid, heated in an oven at 320° C. for 4 hours in the presence of air. The solids obtained were removed, reacted with 100 of 3 wt % alkaline solution in the air, then the alkaline solution was separated from the solids by filtration. The solids obtained were washed, dried and submitted for analysis. The solids contained 0.3 ppm of total selenium. 5 g of thiourea was added to the solution obtained and the pH of the solution was adjusted to pH6.7 to obtain a red precipitate. The precipitate was separated by filtration. The filtrate was recycled for re-use. The precipitate was identified by SEM/EDX analysis as elemental selenium.

### Example 11

300 g of bioreactor sludge, which contained 900 ppm of total selenium in solids (dried basis), was centrifuged, the solids obtained were separated from the liquid, heated in an oven at 310° C. for 4 hours in the presence of air. The solids obtained were removed, reacted with 100 mL of 3 wt % of sodium bicarbonate solution in the air, then the alkaline solution was separated from the solids by filtration. The solids obtained were washed, dried and submitted for analysis. The solids contained 0.4 ppm of total selenium. 5 g of hydroxyl amine was added to the solution obtained and the pH of the solution was adjusted to pH7 to obtain a precipitate. The precipitate was separated by filtration. The filtrate was recycled for re-use. The precipitate was identified by SEM/EDX analysis as elemental selenium.

### Example 12

300 g of bioreactor sludge, which contained 1900 ppm of total selenium in solids (dried basis), was centrifuged, the solids obtained were separated from the liquid, heated in an oven at 340° C. for 4 hours in the presence of air. The solids obtained were removed, reacted with 100 mL of 3 wt % of potassium hydroxide solution in the air, then the alkaline solution was separated from the solids by filtration. The solids obtained were washed, dried and submitted for analysis. The solids contained 0.2 ppm of total selenium. 10 g of ferrous chloride was added to the solution obtained, while mixing, to obtain a precipitate. The precipitate was separated by filtration. The precipitate was washed and dried at 100° C. for four hours. Based on the results of the analyses, the precipitate obtained contained iron oxyhydroxides and iron selenite.

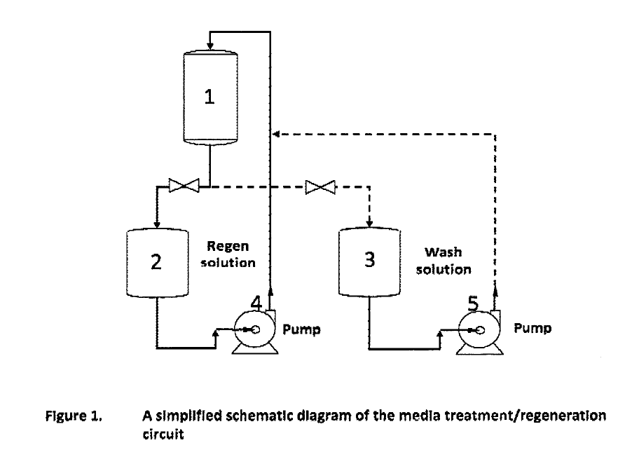

The method and process of selenium removal and recovery from the materials, including, but not limited to, waste adsorbent, bioreactor sludge, any types of membranes and filters, ion exchange resins, solar cells, and electronic devices, which contain selenium and selenium compounds in any form, was proposed. The membranes to be treated could include, but not limited to, reverse osmosis (RO), nanofiltration (NF), ultrafiltration (UF), microfiltration (MF), electrodialysis reversal (EDR), membranes. According to the invention, the material for the removal of selenium is reacted with highly alkaline solution or alkaline solution in the presence of sulfide, which enhances the dissolution of the selenium species present. Depending on the specific solids, which require treatment for selenium removal, the contact with solution, which is used for selenium dissolution, may be conducted in a fixed-bed column, or in a fixed-bed membrane bioreactor, or in a fixed membrane, or on a filter, or in a reaction tank, where the solid material is placed, or in a fluidized bed reactor with stirrer, or on a belt filter, etc. A simplified schematic diagram of one of the possible circuit designs for the material treatment to remove selenium is shown in FIG. 1.

The methods or processes described below are an example of an embodiment of the claimed invention. It must be noted, that the schematics described here do not limit the claimed invention, which may cover processes or methods that are not described in the present document. The applicants, inventors and owners reserve all rights in any invention disclosed herein including also methods and processes described herein, which are not claimed in this document.

The equipment for the treatment of material (1) shown in FIG. 1 includes two tanks (2) and (3), two recirculation pumps (4) and (5). The equipment used also includes any solid/liquid separation devise to separate the selenium, which is not shown here for the reason of simplicity of the circuit. Depending on the volume of the material to be treated, any solid-liquid separation devices known in the art, such as centrifuge, clarifier, thickener, filters (bag filter, belt filter, press filter, membrane filter) to collect selenium which was extracted from the media and then precipitated, can be used. Please note that the material 1 could use any type of vessel in any form, design, with or without stirrer, including fixed bed, fixed-bed membrane bioreactor, moving bed or fluidized bed media, in a batch or continuous mode of operation, in-situ or ex-situ.

The tank 2 is filled with a solution, which is prepared in the same tank by dissolving reagents, such as, but not limited to, sodium hydroxide and/or sodium sulfide, in water. This solution is circulated through the bed of material to be treated (e.g., adsorbent, bioreactor sludge) 1 to dissolve and remove selenium. The tank 3 is filled with water. After the most of selenium is extracted by circulating the solution in the first tank, residual dissolved selenium compounds are removed by circulating water from the second tank through the bed. The solution with the dissolved selenium and the rinse water are then combined in tank 2 and treated to precipitate elemental selenium using different options. The first tested option to precipitate elemental selenium includes using oxidizing compounds, such as, but not limited to, sodium percarbonate, sodium persulfate, hydrogen peroxide, sodium chlorate, oxygen or any mixture thereof. The second tested option to precipitate elemental selenium with some selenium sulfides from the alkaline sulfide solutions by addition of mineral or organic acids or mixture thereof with some selenium sulfides. The third tested option is the addition of reducing agents, such as, but not limited to, ascorbic acid, thiourea, hydroxyl amine, glucose, or any mixture thereof. The third option is recommended for application to alkaline and alkaline sulfide solutions with very low sulfide concentrations. The fourth tested option is to precipitate selenium as selenium salts, by addition of different compounds, such as, but not limited to, ferric and ferrous chlorides, tin salts, or mixture thereof.

The precipitated selenium or selenium compounds are separated from the liquid phase using any solid/liquid separation method, including, but not limited to, a filter (a bag filter, a belt filter, a filter press, a cartridge filter, a membrane filter), a centrifuge, a thickener, a clarifier. For large volumes of the material a thickener prior to filtration may be required. The filtrate after the removal of selenium and or selenium compounds is reused in the process or discharged.

The solids obtained after the removal of selenium can be re-used, recycled or discarded as a non-hazardous waste.

PATENT CITATOONS

| | Filing | Publication | | |
|---|---|---|---|---|
| Cited Patent | date | date | Applicant | Title |
| CA1337019C | Oct. 4, 1988 | Sep. 19, 1995 | Ronald Glen Lang | Biorecovery of |
| | | | McCready | selenium |
| US4377486 | Dec. 24, 1980 | Mar. 22, 1983 | Wrc Processing | Acidification, |
| | | | Company | oxidation to |
| | | | | rupturing cellular |
| | | | | structures |
| US4519913 | Jun. 1, 1984 | May 28, 1985 | Kerr-Mcgee | Process for the removal |
| | | | Corporation | and recovery of selenium |
| | | | | from aqueous solutions |
| WO2009010922A2 | Jul. 15, 2008 | Jan. 22, 2009 | Aliment Kft | Process for producing |
| | | | | elemental selenium |
| | | | | nanospheres |
| CA1337019C | Oct. 4, 1988 | Sep. 19, 1995 | Ronald Glen Lang | Biorecovery of |
| | | | McCready | selenium |
| US6235204 | Apr. 14, 2000 | May 22, 2001 | Radian International | Method and system for |
| | | | Llc | removal of selenium |
| | | | | from FGD scrubber purge |
| | | | | water |
| US7550087 | Dec. 11, 2006 | Jun. 23, 2009 | Zenon Technology | Denitrifying a waste |
| | | | Partnership | stream followed by |
| | | | | anoxic treatment to |
| CA2819777 A1 | Nov. 4, 2011 | Jun. 21, 2012 | General Electric | Selenium separation and |
| | | | Company | recovery from bioreactor |
| | | | | sludge |
| US4377486 A | Dec. 24, 1980 | Mar. 22, 1983 | Wrc Processing | Acidification, |
| | | | Company | oxidation to |
| | | | | rupturing cellular |
| | | | | structures |
| EP2651817 A1 | Dec. 17, 2010 | Oct. 23, 2013 | General Electric | Selenium recovery from |
| | | | Company | bioreactor sludge |
| EP2651818 A1 | Nov. 4, 2011 | Oct. 23, 2013 | General Electric | Selenium separation and |
| | | | Company | recovery from bioreactor |
| | | | | sludge |
| WO2012082251 A1 | Nov. 4, 2011 | Jun. 21, 2012 | General Electric | Selenium separation and |
| | | | Company | recovery from bioreactor |
| | | | | sludge |

We claim the invention of the following:

1) The method and process of selenium recovery from a solid material, which contains selenium in any form, such as elemental selenium or selenium compounds, using reaction with alkaline and sulfide solutions, followed by solid/liquid separation and selenium recovery from the liquid phase obtained by precipitation as elemental selenium or selenium compounds.

2) The method and process in claim 1, where the solid material is, but not limited to, an adsorbent, ion exchange resin, electronic device, bioreactor sludge, material obtained from mineral processing, different industrial wastes, metallurgical wastes, solar cell, any types of membranes (e.g., RO, NF, UF, MF, EDR membranes) and filters.

3) The method and process in claim 1, where the solid material is treated to remove selenium using one or more: a fixed bed reactor, moving bed reactor, batch reactor with mixing, bioreactor, continuous reactor, belt filter, in-situ, ex-situ, a permeable reactive barrier.

4) The method and process in claim 2, where the solid material is wet or it has been pre-treated for removal of moisture, using partial decomposition, pyrolysis, or Incineration.

5) The method and process in claim 1, where the selenium is dissolved in alkaline solution which contains sulfide, followed by solid-liquid separation and selenium precipitation.

6) The method and process in claim 5, where the sulfide is any form such as, but not limited to, metal sulfides, polysulfides, hydropolysulfides, hydrogen sulfide, hydrogen polysulfide, polysulfanes, carbon disulfide or any mixture thereof.

7) The method and process in claim 5 where the selenium precipitation is conducted using acid, or oxidizing compound, or reducing compound, or salts of metals, or any mixture thereof.

8) The method and process in claim 6, where the acid is inorganic or organic acid, such as, but not limited to, hydrochloric acid, ascorbic acid, citric acid, and any mixture thereof.

9) The method and process in claim 6 where the oxidizing compound is, but not limited to, sodium percarbonate, hydrogen peroxide, oxygen, sodium chlorate, potassium persulfate, peroxymonosulfuric acid, or any mixture thereof.

10) The method and process in claim 6 where the reducing compound is, but not limited to, hydroxyl amine, thiourea, ascorbic acid, citric acid and any mixture thereof.

11) The method and process in claim 6 where the salts of metals are, but not limited to, ferrous chloride, ferric chloride, tin chloride, or any mixture thereof.

12) The method and process in claim 1, where the selenium is dissolved in alkaline solution, followed by solid-liquid separation and selenium precipitation.

13) The method and process in claim 12, where the selenium precipitant is, but not limited to, organic acid, inorganic acid, reducing agent, any salt, compound, or any mixture thereof, which form insoluble elemental selenium or selenium compounds.

14) The method and process in claim 13, where the acid is, but not limited to, hydrochloric acid, sulfuric acid, ascorbic acid, citric acid or any mixture thereof.

15) The method and process in claim 13, where the reducing selenium precipitant is, but not limited to, hydroxylamine, or ascorbic acid, or thiourea, or glucose, or any mixture thereof.

16) The method and process in claim 15, where thiourea is added to the solution and the pH of the solution is adjusted to less than 7 to precipitate elemental selenium.

17) The method and process in claim 14, where ascorbic acid is added to the solution to precipitate elemental selenium.

18) The method and process in claim 13, where the salt is, but not limited to, ferrous chloride, ferric chloride, tin chloride, or any mixture thereof.

19) The method and process in claims 5 and 12, where the solution obtained from the selenium precipitation is recycled/reused.

20) The method and process in claim 3, where the solid material is recycled/re-used, landfilled or disposed of as a non-hazardous waste.
